(19) United States
(12) Patent Application Publication
(10) Pub. No.: US 2002/0114263 A1
(43) Pub. Date: Aug. 22, 2002

(54) Audio/visual optical disc

(76) Inventor: Kai Leung Fan, Tseung kwan O (HK)

Correspondence Address: Raymond Yat Chan, 1050 Oakdale Ln., Arcadia, CA, 91006, US

(21) Appl. No.: 09/740,075

(22) Filed: Dec. 18, 2000

(51) Int. Cl. G11B 7/24

(52) U.S. Cl. 369/275.3; 369/275.4

(57) ABSTRACT

An audio/video optical disc, which is an extension to the “Philips-Sony” Standards, is maximized to 1100 Mbyte which equivalents to 127 minutes of VCD recording time while accommodating the disc and the Servo Firmware without changing the pickup and writing strategy and giving up of the existing industry platform, wherein the medium has been optimized for the 0.50 NA in 1× video recording by setting the atomic ratio of the memory alloy to the optimum with impurity doping.

### BACKGROUND OF THE PRESENT INVENTION

1. Field of the Present Invention

The present invention relates to optical disc, and more particularly to an audio/visual (recordable or rewritable) optical disc which capacity is maximized to 1110 Mbyte which equivalents to 127 minutes of MPEG1 VCD recording time while accommodating the disc and the Servo Firmware without changing the recorder pickup head.

2. Description of the Related Arts

The conventional compact disc (CD) technology share some common features including the 0.45 NA pickup head, 780 nm laser diode wavelength, 650 Mbyte storage capacity, 20 mm/80 mm disc diameter and etc. The physical specifications for all the newly developed logical formats such as VCD, S-VCD, CDDA, CD-ROM have been established by “Philips” and “Sony” based on a 0.45 NA pickup system. The compact disc (CD) technology opens not only the optical storage market but also a technical and industrial platform for developing higher storage capacity discs. The DVD family of products is an example and extension of the CD family of products.

In other words, the capacity of compact disc (VCD, CD-ROM, S-VCD, Photo-CD, CD-I) has been limited to 650 Mbyte by “Philips” and “Sony” Standard Books. Hence the Recordable (CD-R) and Rewritable (CD-RW) blank optical discs in the market have been designed by “Philips” and “Sony” with capacity of 650 Mbyte as to match the well established logical formats. This equivalents to 74 minutes recording time for CD-Audio and VCD program and about 40 minutes recording time for S-VCD. The capacity limit of the blank optical disc prevents the market penetration of the Video Disc Recorder which serves to replace the Video Cassette Recorder in the market. Obviously, a 74 minutes low quality video recording time and a 40 minutes high quality video recording time is not adequate for the market development of the Video Disc Recorder.

As to extend the life of the traditional 780 nm optical pick-up, an extended-play-time disc format is proposed based on the existing 780 nm wavelength, 0.50 NA pickup for optical disc. Part of the format applies both to the Read-Only Disc and the Writable/Rewritable disc while the others applies only to the rewritable optical disc.

The high density DVD family of recordable/rewritable products do allow higher storage density due to smaller recording spot. However, the cost of manufacturing is too high and this also mean a total given up of the existing platform.

Accordingly, the conventional compact disc products are suffered from the following drawbacks.

First, the relatively small storage capacity of the CD-R and CD-RW limits the market growth for the Video Disc Recorder for replacing the traditional Video Cassette Recorder.

Second, the conventional CD-R or CD-RW allows only in-groove-recording hence takes two discs to store a one hour video program in low quality VCD format and more in higher quality S-VCD format.

The barrier for capacity extension of the traditional compact disc is both physical and logical related.

A Logical Format is a protocol in which the hardware can signify the disc and activates a servo control loop for reading and writing. The coding method in the format includes the necessary information for addressing, identity and drive control. In the traditional time addressing format, all digits are represented in Binary Coded Decimal (BCD), including a Minutes field, a Second field and a Frame field, i.e. representing in Minute:Second:Frame as a video recorder. However, the definition is difficult to those in the other inventions. The BCD in the traditional time addressing format limits the maximum addressable time to 99:59:74 while usually only 74:59:74 or less are used in the traditional CD. Such kind of BCD time code are modulated into the blank media tracking groove by means of wobble and appears in a read-only CD as digital codes.

According to the applications of the “Philips/Sony” CD-RW, the conventional address coding method allows the disc address of up to 700 Mbyte or “79 mionutes:59 seconds and 74 frames” without providing any method for further addressing.

Besides, the conventional manufacturing process of phase change rewritable disc technology yields wide and big information marks which gives high cross-talk and jitter while narrowing the track pitch. This results in decoding error. Besides, due to finite tracking spot dimension, the spot will see part of the adjacent tracks while decreasing the track pitch and results in tracking error. Those sets the hard physical limit for rewritable disc. Furthermore, the conventional blank optical disc records only in the . Such factors limit the capacity of the conventional blank optical storage media (CD-R/CD-RW) to 650 Mbyte or nearby.

Another major barrier in extending the storage capacity is the resolving powder of pick up objective lens which limits finite dimension of the focused laser spot. Generally speaking, the resolving powder is limited by the numerical aperture (NA) of the optical pickups. The Full-Width-Half maximum intensity spot dimension (FWHM) is about 0.5A/NA which indicates that the information pit width and track pitch must be in the same order of magnitude as the recording spot and reading spot. This determines the track pitch and linear velocity and hence limits both the radial and tangential density of the information pits. The conventional compact disc products use 0.45 NA and yield a maximum capacity of about 700 MByte. Nowadays, the 0.5 NA pickup head has been used in the market available recorder and has been a mature technology which indicates that extending the capacity of compact disc has been commercially possible.

Capacity of an optical disc can be generally increased by increasing the recording density of the information pits or marks. This can be done decreasing the linear velocity and decreasing the track pitch.

However, the growth in capacity has been limited by the following factors. The first is the increasing track-to-track cross-talk which results in block decoding error due to the increase in the track density. The second is the conventional addressing coding method that only allows the disc to be addressed up to 99 minutes:59 seconds and 74 frames. However, the existing standard further limits it to 79 minutes:59seconds and 74 frames. There is no easy method for further addressing. The third is a different drop ratio in I3 signal in comparison to I11 signal as compared to the lower capacity disc. The forth is the physical dimension of a compact disc itself and the loader mechanism of a recorder/player. The firth is the digital servo control firmware which can identify the additional minutes in this long play rewritable disc and equalize the HF signal.

### SUMMARY OF THE PRESENT INVENTION

It is an objective of the present invention to provide an audio/visual optical disc, with only tracking on groove for recording, which is capable recording 1110 Mbyte of storage capacity for audio/visual information. This is equivalent to 127 minutes of MPEG-1 VCD program recording time.

Another objective of the present invention is to provide an audio/visual optical disc, which successfully enables tracking on land for recording so as to provide both groove and land recording, so that the data capacity can be substantially maximized to 2.2 Gigabyte that is equivalent to 254 minutes of MPEG-1 VCD quality program.

Another objective of the present invention is to provide an audio/visual optical disc having a diameter of 130 mm so as to allow larger capacity and creates no confusion to the consumer with the conventional compact disc and DVD.

Another objective of the present invention is to provide an audio/visual optical disc having a time address extended to 159 minutes:59 seconds:74 frames.

Another objective of the present invention is to provide an audio/visual optical disc which minimizes the jitter and crosstalk and improves the decoding error margin.

Another objective of the present invention is to provide an audio/visual optical disc which has been optimized for the 0.5 NA in 1× recording by setting the atomic ratio of the phase change alloy (AgInSbTe) of the memory layer to the optimum by doping with at least a high melting point compound.

Another objective of the present invention is to extend the recording time of an audio/visual optical disc by physically narrowing the track pitch and lowering the recording linear velocity.

Accordingly, in order to accomplish the above objectives, the present invention provides an audio/visual (rewritable) optical disc for audio and visual data, which comprises a pre-grooved polycarbonate substrate having a base surface and a data surface provided with continuous spiral tracks from inner to outer radius. The distance between the groove tracks are identified as lands. On the pre-grooved polycarbonate substrate, a stack of different materials is sputtered to form a four sputtered layer and a spin coated protective lacquer on top and bottom.

The first sputtered layer is a dielectric heat barrier layer. The second sputtered layer is a memory layer provided on the dielectric heat barrier layer. The third sputtered layer is second dielectric heat diffusion controller layer which is provided on top of the memory layer. The fourth sputtered layer is a reflective heat sink layer provided on the second dielectric heat diffusion controller.

The memory layer is made of Silver-Indium-Antimory-Tellerium alloy doped with high melting point compound such as Vanadium Oxide. In the writing process, the disc is illuminated by focused laser which the alloy layer is heated up to above the melting point and cools down quickly to leave the alloy in amorphous state which can be observed as a mark with different contrast. Such marks cause a difference in the reflected signal and hence can be used for data storage. In the erasing process, the alloy is heated up to above the crystallization temperature to restore the amorphous mark to the highly reflective crystalline state.

### BRIEF DESCRIPTION OF THE DRAWINGS

FIG. 1 is a front view of an audio/visual optical disc according to the preferred embodiment of the present invention.

FIG. 2 is partial sectional view of a portion encircled by a dotted circle S in the FIG. 1 according to the above preferred embodiment of the present invention.

FIG. 3 is an enlarged front view of a portion of the audio/visual optical disc, illustrating the groove and land tracks provided on the data surface of the audio/visual optical disc, according to the above preferred embodiment of the present invention.

FIG. 4 is a perspective view of a loader tray adapted for loading the audio/visual optical disc into an optical disc recorder or player according to the above preferred embodiment of the present invention.

### DETAILED DESCRIPTION OF THE PREFERRED EMBODIMENT

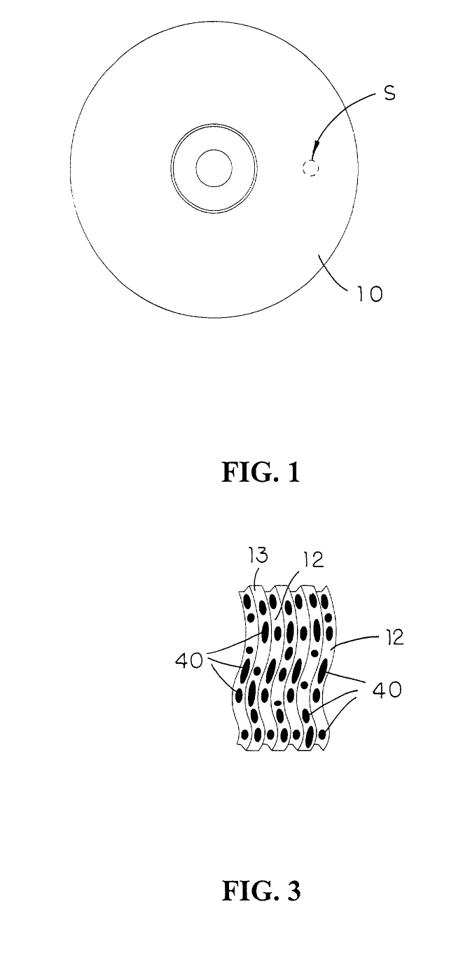

Referring to FIGS. 1 to 3, the present invention provides an audio/visual optical disc, which can be a rewritable or recordable optical disc, i.e. AVRW disc, adapted to be formatted as a VCD,-S-VCD,CDDA,CD-ROM.

AV-RW—optical disc of the present invention is a removable and rewritable optical disc intended for AV data storage even though it is not limited for the AV data storage. It is a blank media serving the purpose similar to a piece of white paper with pre-printed writing guide lines.

As to simplify the hardware design and make the hardware easier compatible with the market available recordable discs. The audio/visual (rewritable) optical disc of the present invention uses the same set of address location as the “Philips/Sony” CD-RW specifications with some additional parameters, a different time coding method and parameter definitions.

According to the present invention, the recording time of the audio/visual optical disc is lengthened through both the physical and local formats.

In view of the physical format for the Groove-Recording Format Rewritable, we would like to extend the recording time by physically narrowing the track pitch and lowering the recording linear velocity. However, the increasing track-to-track cross-talk would result in block decoding error due to the increasing in track density. The solution is to optimize the 0.50 NA optical recorder in 1× video recording of the optical disc by setting the atomic ratio of the memory alloy to the optimum with impurity doping. Besides, a different groove specification is employed. This is also minimizes the jitter and improves the decoding error margin.

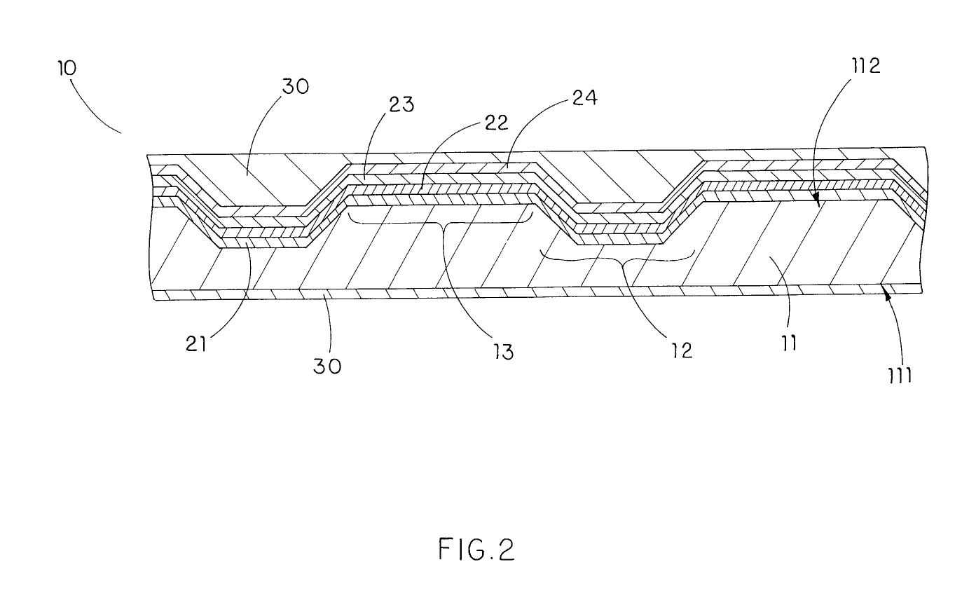

Accordingly, referring to FIG. 2, the audio/visual optical disc 10 according to the present invention comprises a pre-grooved polycarbonate substrate 11. On the pre-grooved polycarbonate substrate 11, a stack of different materials is sputtered to form four sputtered layers. The first sputtered layer is a dielectric heat barrier layer 21. The second sputtered layer is a memory layer 22 provided on the dielectric heat barrier layer 21. The third sputtered layer is second dielectric heat diffusion controller layer 23 which is provided on top of the memory layer 22. The fourth sputtered layer is a reflective heat sink layer 24 provided on the second dielectric heat diffusion controller 23.

The polycarbonate substrate 11 has a base surface 111 and a data surface 112 provided with a continuous spiral groove that defines rounds of groove track 12 spaced with lands 13 extended radially from inner to outer radius. The distance between the groove tracks 12 are identified as lands 13.

The dielectric heat barrier layer 21 is sputtered on the data surface 112 of the substrate 11. The memory layer 22, which is sputtered on the dielectric heat barrier layer 21, is made of a phase change alloy doped with a high melting point compound having a melting point higher than the phase change alloy, wherein an atomic ratio of the memory layer 22 can be set to an optimum with the impurity (high melting point compound) doping. The dielectric heat diffusion controller layer 23 is sputtered on the memory layer 22. The reflective heat sink layer 24 is sputtered on the dielectric heat diffusion controller layer 23.

A spin coated protective lacquer layer 30, adapted for providing exterior protection to the audio/visual optical disc 10, is coated on the base surface 111 of the substrate 11 and the reflective heat sink layer 24 provided on the data surface 112 of the substrate 11.

The groove tracks 12 are produced on the substrate 11 in wobble form by means of pre-grooved stamper made by mastering. Wobble formed on the stamper is replicated to the substrate 11 from the stamper by means of injection molding. The dielectric heat barrier layer 21, the dielectric heat diffusion controller layer 23 and the memory layer 22 are deposited on the substrate 11 by sputtering. The protective lacquer layer 30 is coated around the sputtered stack. During the initializing process to activate the optical disc for recording, the audio/visual optical disc changes from the low reflectivity amorphous state to high reflectivity polycrystalline state by laser heating. This makes the audio/visual optical disc recordable in a video disc recorder. On erasing, the laser of the recorder heats up the memory alloy above the crystalline temperature and restore in into the polycrystalline structure.

According to the preferred embodiment of the present invention, the dielectric heat barrier layer 21 is ZnS.SiO2 which is a heat barrier to avoid the polycarbonate substrate 11 from getting melt. The phase change alloy of the memory layer 22 is Silver-Indium-Antimory-Tellerium alloy (AgInSbTe), wherein the embodied alloy contains 3-10% by weight of the silver, 3-10% by weight of the indium, 40-70% by weight of the antimory, and 20-40% by weight of the tellerium. The high melting point compound doped in the phase change alloy of the memory layer 22 is vanadium oxide. The dielectric heat diffusion controller layer 23 is ZnS.SiO2 for controlling the heat diffusion from the AgInSbTe of the memory layer 22 to the heat sink layer 24. The reflective heat sink layer 24 is AlTi. A hardcoat can be provided at the base surface of the polycarbonate substrate 21 for further protection.

Therefore, in accordance with the present invention, the memory layer 22 is made of the 97-99% by weight of Silver-Indium-Antimory-Tellerium alloy doped with 1-3% by weight of the vanadium oxide. As to make the groove tracks 12 slim and clear, the groove tracks 12 bottom of the audio/visual optical disc 10 is about 300-350 nm while the groove depth is about 40-50 nm. The Vanadium Oxide is doped to the sputtering target to improve the heat margin such that the recording marks 40 are confined to the top area of the groove track 12 as slim and clear marks 40 that minimizes crosstalk and jitter. The doping is done in the target manufacturing process.

Doping can be done in two ways. A more controllable way is to mix the vanadium oxide powder with the Ag, In, Sb and Te powder before being hot pressed into a piece of target.

An alternative way is an uncontrolled way in which an AgInSbTe target is doped with 1-3% of vanadium. In the sputtering process, oxygen is injected into the sputtering chamber. This will cause reactive sputtering which metal oxide can be formed. However, this can also work but the oxides are not limited to vanadium oxide but also including the silver oxide, indium oxide, antimory oxide, and tellerium oxide.

The principle of doping is to add at least a kind of high melting point compound to the phase change alloy as to change the heat diffusion rate on the memory layer 22 made. The vertical cooling rate of the memory layer 22 has been controlled by the ZnS.SiO2 layer between the AgInSbTe and the AlTi in the heat sink layer 24. However, the horizontal heat penetration rate and the mobility of the alloy atoms are limited by the high melting point compound present inside the memory layer 22. As the activity of the memory layer 22 during laser exposure is both a function of the temperature and the heat response of the memory layer 22, we doped some high melting point compounds to the phase change alloy to serve as some high temperature hurdles as to slow down the state change of alloy. This can make the mark more slim and clear to minimize crosstalk and jitter.

The following in the general specifications of an embodied audio/visual (rewritable) optical disc according to the preferred embodiment of the present invention.

Audio/Visual (Rewritabe) Optical Disc (Groove Recording Only)

| Item | Specifications |
|---|---|
| Writing Laser Wavelength | 780 nm +/− 5 nm |
| Numerical Aperture(NA) | 0.50 +/− 0.01 |
| Recording/Playback | |
| Track Pitch | 1.30 +/− 0.10 um |
| Scanning Linear Velocity | 1.1 0 m/s +/− 0.1 m/s |
| Addressing Method | 22.05Khz Wobble with time information |
| | M1M2:S1S2:F1F2, in which |
| | M1: 0,1,2,3,45,6,7,8,9,A,B,C,D,E,F, |
| | M2,S1,S2,F1,F2: 0,1,2,3,4,5,6,7,8,9 |
| Starting Diameter Wobble | <Φ46 mm |
| Maximum Diameter for | <128 mm |
| Wobble | |
| Maximum Wobble | <30 nm |
| Amplitude | |
| Reference Disc Capacity | 1100Mbyte, 127 Minutes, Groove |
| | Recording (Tp1.3 um, Lv1.1 m/s, Φ130 mm) |
| | 1050Mbyte (120 Minutes, Groove |
| | Recording (Tp1.26, Lv 1.0, Φ120 mm) |

*Tp: Track Pitch, Lv: Linear Velocity

Traditionally, memory layer is made of phase change alloy only and the minimum track pitch for both the groove tracks and lands must be 2.5 um to prevent cross-talk. Therefore, groove recording is the normal standard. However, as disclosed above, by doping the phase change alloy of the memory layer 22 with high melting point compound such as vanadium oxide, a heat barrier is formed in the phase change alloy to decrease its heat conductivity. The vanadium oxide absorbs some of the heat and slows down the state change of phase change alloy. This technology enables the track pitch reducing to a minimum of 1.30 um+/−0.10 um but still can make the marks 40 slim and clear enough to minimize crosstalk and jitter. Therefore, more groove tracks 12 can be provided on the substrate 11 for groove recording.

Moreover, in order to have more storage capacity, land recording is also possible after the groove has been fully recorded. Land recording is possible with the audio/visual (rewritable) optical disc 10 of the present invention, as shown in FIG. 3, as the track pitch is adjusted to about 1.5-2 um, preferable 1.7 um, both the groove tracks 12 and lands 13 can be recorded by signal polarity inversion with recording marks 40 clear enough to avoid crosstalk and jitter.

Audio/Visual (Rewritabe) Optical Disc (Groove and Land Recording
Only)

| Item | Specifications |
|---|---|
| Writing Laser Wavelength | 780 nm +/− 5 nm |
| Numerical Aperture (NA) | 0.50 +/− 0.01 |
| Recording/Playback | |
| Track Pitch | 1.50-2.0 um |
| Scanning Linear Velocity | 1.10 m/s +/− 0.1 m/s |
| Addressing Method | 22.05Khz Wobble with time information |
| | M1M2:S1S2:F1F2, in which |
| | M1: 0,1,2,3,45,6,7,8,9,A,B,C,D,E,F, |
| | M2,S1,S2,F1,F2: 0,1,2,3,4,5,6,7,8,9 |
| Starting Diameter Wobble | <Φ46 mm |
| Maximum Diameter for | <128 mm |
| Wobble | |
| Maximum Wobble | <30 nm |
| Amplitude | |
| Reference Disc Capacity | 1400Mbyte, 160 Minutes, Groove & Land |
| | Recording (Tp1.7 um, Lv1.1 m/s, Φ120 mm) |
| | 1600Mbyt (182 Minutes, Groove and Land |
| | Recording (Tp1.55, Lv 1.05, Φ120 mm) |

In the writing process, the audio/visual optical disc 10 is illuminated by focused laser which the memory layer 22 is heated up to above the melting point and cools down quickly to leave the Silver-Indium-Antimory-Tellerium alloy in amorphous state which can be observed as amorphous marks 40 with different contract, as shown in FIG. 3. Such amorphous marks 40 cause a difference in the reflected signal and hence can be used for data storage. In the erasing process, the Silver-Indium-Antimory-Tellerium alloy is heated up to above crystallization temperature to restore the amorphous marks 40 to the highly reflective crystalline state.

Moreover, as to allow larger capacity and creates no confusion to the consumer with the conventional contact disc and DVD, the dimension of the audio/visual optical disc of the present invention is preferred to set to have a diameter of 130 mm even though it is not limited to the above dimension. The 130 mm disc will not be able to be inserted into the conventional loader tray made only accommodating the conventional compact disc having a diameter of 80 mm or 120 mm.

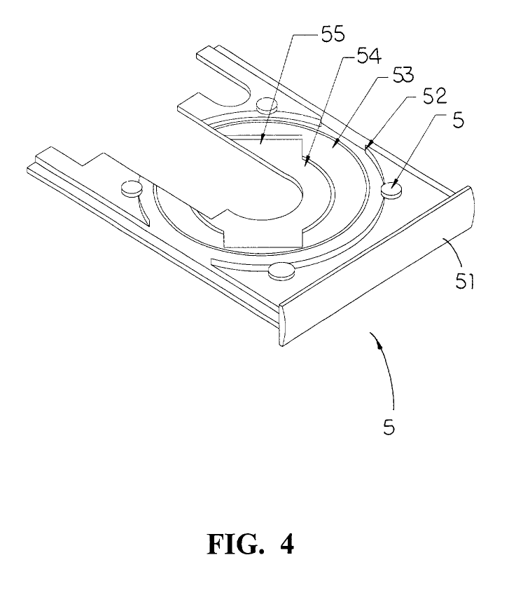

As shown in FIG. 4, a load tray 5 of an optical disc recorder or player is illustrated with comprises a tray 51. On the tray 51, an outer disc groove 52 having a diameter equal to or slightly larger than 130 mm is indented to fittingly receive the optical disc 10 of the present invention therein. Additional first and second inner disc grooves 53, 54 each having a diameter equal to or slightly larger than 120 mm and 80 mm are also concentrically provided on the outer disc groove for fittingly receiving the conventional compact discs. A rectangular groove 55 is overlappedly and concentrically formed on the second inner disc groove 54 adapted to receive a rectangular namecard disc. Moreover, four disc locks 56 are spacedly affixed to a peripheral edge of the outer disc groove 52 to prevent the optical disc from falling off in the cases of vertical loading.

A logical format is a protocol in which the hardware can signify the optical disc and activate a servo control loop for reading and rewriting. The coding method is the format includes the necessary information for addressing, identity and drive control. According to the present invention, the address is represented in Minute:Second:Frame as a video recorder. It employs a total of 24 bits to represent the time address, wherein four bits are used for each digit.

As mentioned in the background of the present invention, in the traditional time addressing format, all digits are represented in Binary Coded Decimal (BCD) which limits the maximum addressable time to 99:59:74. Accordingly, 75 frames are present in one second and 60 seconds are presented in one minute. In other words, the maximum recordable and readable time address based on the existing industry platform is below 100 minutes even though it has been further confined by the Philips/Sony company specifications to 79 minutes:59 second:74 frames.

As to maintain the maximum compatibility with the traditional coding method, an innovative coding method is preferred to be used for the audio/visual (rewritable and recordable) disc of the present invention, wherein the first digit of the minutes of the minute field is represented in hexadecimal format with four binary data bits. Hence the 0-9 is the same as BCD coding while 11-15 is an extension represented by “A,B,C,D,E, and F” which allow the existing proprietary recorder to recognize the optical disc and generate the time address for the digital optical disc.

In the Hexadecimal-BCD format of the present invention, the tie address can be represented as:

M1M2:S1S2:F1F2 wherein

M1 is represented in Hexadecimal format (0,1,2,3,4,5,6,7,8,9,A,B,C,D,E,F), which fully utilizes the four addressing bits in the M1 frame;

M2,S1,S2,F1,F2 are represented in Binary Coded Decimal format (0-9) For example:

Address, 56 minutes:37 seconds:72 frames are represented by three data bytes (24 bits)

01010110 00110111 01110010

One example of the application is the Video Disc Recorder, wherein the audio/visual optical disc according to the present invention with dimension of 130 mm diameter can store up to 127 minutes:59 seconds:74 frames of video program in MPEG-1 VCD format and hence the maximum time address is,

| Field | M1 | M2 | M3 | M4 | M5 | M6 |
|---|---|---|---|---|---|---|
| Decimal | 12 | 7 | 5 | 9 | 7 | 4 |
| Hexa-BCD | 1100 | 0111 | 0101 | 1001 | 0111 | 0100 |

When recording, the time code is generated by a CPU system continuously with a look up table and registered in a media depending on applications. One can use bi-phase FM modulation to incorporate the address in a wobble signal for groove generation in a blank media stamper or multiplexed with user data prior to the digital EFM signal generation in the read-only disc stamper. A commercial video disc recorder can also generate the time code during recording and transformed in into pits and lands on the audio/visual (recordable) optical disc of the present invention.

Accordingly, the recording time code can be extended from 99:59:74 to 159:59:74. In practical application, users may vary the recording time depending on applications. For video recorder, the time address of the blank optical disc is modulated into a 22.05 KHz wobble signal, which makes tracking groove on the optical disc. In other words, the 24-bit item coding bit stream after inserting error correction codes can be modulated into the audio/visual-rewritable recording groove by means of bi-phase frequency modulation wherein a carrier of frequency 22.05 KHz is used.

For a recorded media, it is modulated into the data bit stream depending on the format of the optical disc. In other words, the 24-bit time coding stream is multiplexed with the digital video data and error correction codes prior to be converted into the serial FM signal.

Groove recording is normally performed by means of the above described coding mode. However, in order to have more storage capacity, land recording is also possible after the groove has been fully recorded. Land recording has only been possible with audio/visual (rewritable) disc as the crosstalk limit of marks are much lower than those of pits on a read-only format. The audio/visual (recordable) disc based on the write-once dye technology was able to perform land recording as the dye chemical has to be confined in the groove for proper recording quality. In the land recording mode, the time code address has to add a constant offset which equals to the ending address of the groove recording. This further extends the capacity of the audio/visual (rewritable) optical disc to a theoretical limit of 320 minutes or 2.81 Gbyte regardless of disc dimension.

Both the land and groove recording starts from the inner radius along the spiral groove. At the end of the recording groove of the outer radius or approaching a logical end limit of the groove, the Pickup head will fly back and tracks on land for land recording mode. Land and Groove tracking is possible by reversing the polarity of the tracking signal or by software means in the tracking servo loop. As the track pitch for the Land and Groove audio/visual (rewritable) optical disc is higher than the groove only audio/visual (rewritable) optical disc and to be compatible with the market media, the modification of drive servo loop is minimized. As to avoid the break during the pickup head fly back for land and groove switching, a 10 seconds FIFO buffer which equivalents about 3 Mbyte of memory is incorporated. The starting time of the land recording is succeeding the end time of groove recording. A constant offset which equals to the end time address of the groove recording must be added in the drive firmware when decoding.

The addressing method will also allow the drive to address to each frame of a second. The digital timing data is modulated into the 22.05 KHz carrier to generate a wobble groove in the stamper. Other than AV-Rewritable, this addressing method can further be extended to other applications of read only AV-CD, AV-ROM and the Write-Once AV-R.

In some specific sectors at the front of the AVRW, the timing information of the present invention is also used to communicate with the drive to inform the drive about the disc identity such as the total playtime, recording powder, writing speed and etc. Such definitions are presents at the beginning of the Audio/visual optical disc.

What is claimed is:

1. An audio/visual optical disc, comprising:
a pre-grooved substrate having a data surface provided with a continuous spiral groove which defines rounds of groove track spaced with lands along side;
a dielectric heat barrier layer, which is sputtered on said data surface of said substrate for form a heat barrier to avoid said substrate from getting melt;
a memory layer sputtered on said dielectric heat barrier layer for recording data, wherein said memory layer is made of a phase change alloy doped with a high melting point compound having a melting point higher than that of said phase change alloy, so as to set an atomic ratio of said memory layer to an optimum;
a dielectric heat diffusion controller layer, which is sputtered on said memory layer, for controlling heat diffusion from said memory layer;
a reflective heat sink layer sputtered on said dielectric heat diffusion controller layer; and
a spin coated protective lacquer layer coated on said reflective heat sink layer provided on said data surface of said substrate.

2. The audio/visual optical disc, as recited in claim 1, wherein both said groove tracks and said lands are recordable by signal polarity inversion with recording marks, wherein land recording is processed after said groove was fully recorded.

3. The audio/visual optical disc, as recited in claim 1, wherein said memory layer contains 97-99% by weight of said phase change alloy and 1-3% by weight of said high melting point compound.

4. The audio/visual optical disc, as recited in claim 2, wherein said memory layer contains 97-99% by weight of said phase change alloy and 1-3% by weight of said high melting point compound.

5. The audio/visual optical disc, as recited in claim 1, wherein said phase change alloy is a Silver-Indium-Antimory-Tellerium alloy.

6. The audio/visual optical disc, as recited in claim 5, wherein said high melting point compound is vanadium oxide.

7. The audio/visual optical disc, as recited in claim 2, wherein said phase change alloy is a Silver-Indium-Antimory-Tellerium alloy.

8. The audio/visual optical disc, as recited in claim 7, wherein said high melting point compound is vanadium oxide.

9. The audio/visual optical disc, as recited in claim 3, wherein said phase change alloy is a Silver-Indium-Antimory-Tellerium alloy.

10. The audio/visual optical disc, as recited in claim 9, wherein said high melting point compound is vanadium oxide.

11. The audio/visual optical disc, as recited in claim 4, wherein said phase change alloy is a Silver-Indium-Antimory-Tellerium alloy.

12. The audio/visual optical disc, as recited in claim 11, wherein said high melting point compound is vanadium oxide.

13. The audio/visual optical disc, as recited in claim 5, wherein said Silver-Indium-Antimory-Tellerium alloy contains 3-10% by weight of silver, 3-10% by weight of indium, 40-70% by weight of antimory, and 20-40% by weight of tellurium.

14. The audio/visual optical disc, as recited in claim 6, wherein said Silver-Indium-Antimory-Tellerium alloy contains 3-10% by weight of silver, 3-10% by weight of indium, 40-70% by weight of antimory, and 20-40% by weight of tellurium.

15. The audio/visual optical disc, as recited in claim 7, wherein said Silver-Indium-Antimory-Tellerium alloy contains 3-10% by weight of silver, 3-10% by weight of indium, 40-70% by weight of antimory, and 20-40% by weight of tellurium.

16. The audio/visual optical disc, as recited in claim 8, wherein said Silver-Indium-Antimory-Tellerium alloy contains 3-10% by weight of silver, 3-10% by weight of indium, 40-70% by weight of antimory, and 20-40% by weight of tellurium.

17. The audio/visual optical disc, as recited in claim 9, wherein said Silver-Indium-Antimory-Tellerium alloy contains 3-10% by weight of silver, 3-10% by weight of indium, 40-70% by weight of antimory, and 20-40% by weight of tellurium.

18. The audio/visual optical disc, as recited in claim 10, wherein said Silver-Indium-Antimory-Tellerium alloy contains 3-10% by weight of silver, 3-10% by weight of indium, 40-70% by weight of antimory, and 20-40% by weight of tellurium.

19. The audio/visual optical disc, as recited in claim 11, wherein said Silver-Indium-Antimory-Tellerium alloy contains 3-10% by weight of silver, 3-10% by weight of indium, 40-70% by weight of antimory, and 20-40% by weight of tellurium.

20. The audio/visual optical disc, as recited in claim 12, wherein said Silver-Indium-Antimory-Tellerium alloy contains 3-10% by weight of silver, 3-10% by weight of indium, 40-70% by weight of antimory, and 20-40% by weight of tellurium.

21. The audio/visual optical disc, as recited in claim 13, wherein both said dielectric heat barrier layer and said dielectric heat diffusion are made of ZnS.SiO2.

22. The audio/visual optical disc, as recited in claim 15, wherein both said dielectric heat barrier layer and said dielectric heat diffusion are made of ZnS.SiO2.

23. The audio/visual optical disc, as recited in claim 21, wherein said reflective heat sink layer is made of AlTi.

24. The audio/visual optical disc, as recited in claim 22, wherein said reflective heat sink layer is made of AlTi.

25. The audio/visual optical disc, as recited in one of claims 1 to 12, wherein said high melting point compound is doped in said phase change alloy by mixing said high melting point compound with elements of the phase change alloy in powder form before being hot pressed into a piece of sputtering target for sputtering on said dielectric heat barrier layer of said audio/visual optical disc.

26. The audio/visual optical disc, as recited in claim 6, 8, 10, or 12, wherein a sputtering target of said phase change alloy is doped with 1-3% by weight of vanadium, so that during sputtering said phase change alloy on said dielectric heat barrier layer in a sputtering chamber, oxygen is injected into said sputtering chamber, vanadium oxide is formed and doped in said phase change alloy to form said memory layer.

27. The audio/visual optical disc, as recited in claim 1, 6 or 10, wherein said high melting point compound is doped to a sputtering target to improve a heat margin such that recording marks are confined to a top area of said groove in slim and clean manner.

28. The audio/visual optical disc, as recited in claim 27, wherein a track pitch is minimized to 1.30 um+/−0.10 um.

29. The audio/visual optical disc, as recited in claim 2, 8 or 12, wherein said high melting point compound is doped to a sputtering target to improve a heat margin such that recording marks are confined to a top area of said groove in slim and clean manner.

30. The audio/visual optical disc, as recited in claim 29, wherein a track pitch is minimized to 1.5-2 um.

31. The audio/visual optical disc, as recited in claim 27, wherein a groove bottom of said groove is between 300 nm and 350 nm and a depth of said groove is between 40-50 mm.

32. The audio/visual optical disc, as recited in claim 28, wherein a groove bottom of said groove is between 300 nm and 350 nm and a depth of said groove is between 40-50 mm.

33. The audio/visual optical disc, as recited in claim 29, wherein a groove bottom of said groove is between 400nm and 450 nm and a depth of said groove is between 40-50 mm.

34. The audio/visual optical disc, as recited in claim 30, wherein a groove bottom of said groove is between 400 nm and 450 nm and a depth of said groove is between 40-50 mm.

35. The audio/visual optical disc, as recited in claim 1, 2, 10, or 12, wherein said groove is a wobble groove.

36. The audio/visual optical disc, as recited in one of claims 1 to 12, wherein said audio/visual optical disc is made to have a diameter of 130 mm.

37. The audio/visual optical disc, as recited in claim 28, wherein said audio/visual optical disc is made to have a diameter of 130 mm.

38. The audio/visual optical disc, as recited in claim 30, wherein said audio/visual optical disc is made to have a diameter of 130 mm.

39. The audio/visual optical disc, as recited in claim 38, wherein both said land and groove recording start from an inner radius.

40. The audio/visual optical disc, as recited in claim 1, 2, 3, 4, 6, 8, 10, or 12, wherein a time address of said audio/visual optical disc is represented in Hexadecimal/Binary-Coded-Decimal format, wherein a minute field, a second field and a frame field are represented with 24 bits, wherein each of said minute, second and frame fields has a first digit and a second digit and four of said 24 bits are used for each of said first and second digits, wherein said first digit of said minute field is represented in a Hexadecimal format with four binary data bits while said second digit of said minute field, said first and second digits of said second field and said first and second digits of said frame field are represented by a Binary-Coded-Decimal format.

41. The audio/visual optical disc, as recited in claim 25, wherein a time address of said audio/visual optical disc is represented in Hexadecimal/Binary-Coded-Decimal format, wherein a minute field, a second field and a frame field are represented with 24 bits, wherein each of said minute, second and frame fields has a first digit and a second digit and four of said 24 bits are used for each of said first and second digits, wherein said first digit of said minute field is represented in a Hexadecimal format with four binary data bits while said second digit of said minute field, said first and second digits of said second field and said first and second digits of said frame field are represented by a Binary-Coded-Decimal format.

42. The audio/visual optical disc, as recited in claim 26, wherein a time address of said audio/visual optical disc is represented in Hexadecimal/Binary-Coded-Decimal format, wherein a minute field, a second field and a frame field are represented with 24 bits, wherein each of said minute, second and frame fields has a first digit and a second digit and four of said 24 bits are used for each of said first and second digits, wherein said first digit of said minute field is represented in a Hexadecimal format with four binary data bits while said second digit of said minute field, said first and second digits of said second field and said first and second digits of said frame field are represented by a Binary-Coded-Decimal format.

43. The audio/visual optical disc, as recited in claim 37, wherein a time address of said audio/visual optical disc is represented in Hexadecimal/Binary-Coded-Decimal format, wherein a minute field, a second field and a frame field are represented with 24 bits, wherein each of said minute, second and frame fields has a first digit and a second digit and four of said 24 bits are used for each of said first and second digits, wherein said first digit of said minute field is represented in a Hexadecimal format with four binary data bits while said second digit of said minute field, said first and second digits of said second field and said first and second digits of said frame field are represented by a Binary-Coded-Decimal format.

44. The audio/visual optical disc, as recited in claim 38, wherein a time address of said audio/visual optical disc is represented in Hexadecimal/Binary-Coded-Decimal format, wherein a minute field, a second field and a frame field are represented with 24 bits, wherein each of said minute, second and frame fields has a first digit and a second digit and four of said 24 bits are used for each of said first and second digits, wherein said first digit of said minute field is represented in a Hexadecimal format with four binary data bits while said second digit of said minute field, said first and second digits of said second field and said first and second digits of said frame field are represented by a Binary-Coded-Decimal format.

45. The audio/visual optical disc, as recited in claim 40, wherein said audio/visual optical disc has a maximum capacity of 1100 Mbyte and is able to be stored up to 159 minutes 59 seconds and 74 frames of video program in MPEG-1 VCD format.

46. The audio/visual optical disc, as recited in claim 43, wherein said audio/visual optical disc has a maximum capacity of 1100 Mbyte and is able to be stored up to 159 minutes 59 seconds and 74 frames of video program in MPEG-1 VCD format.

47. The audio/visual optical disc, as recited in claim 44, wherein said audio/visual optical disc has a maximum capacity of 2.81 Gbyte and is able to be stored up to 318 minutes 59 seconds and 74 frames of video program in MPEG 1 VCD format.

48. The audio/visual optical disc, as recited in claim 45, wherein digital timing data is modulated into a 22.05 KHz wobble signal which makes grooves on said audio/visual optical disc.

49. The audio/visual optical disc, as recited in claim 46, wherein digital timing data is modulated into a 22.05 KHz wobble signal which makes grooves on said audio/visual optical disc.

50. The audio/visual optical disc, as recited in claim 47, wherein digital timing data is modulated into a 22.05 KHz wobble signal which makes grooves on said audio/visual optical disc.

51. The audio/visual optical disc, as recited in claim 48, having a maximum groove amplitude of 30 nm.

52. The audio/visual optical disc, as recited in claim 49, having a maximum groove amplitude of 30 nm.

53. The audio/visual optical disc, as recited in claim 50, having a maximum groove amplitude of 30 nm.

54. An audio/visual optical disc having a diameter of 130 mm, a maximum capacity of 1100 Mbyte with groove recording, a recording time code as long as 159 minutes:59 seconds:74 frames, and a track pitch as short as 1.30 um+/−0.10 um.

55. An audio/visual optical disc having a diameter of 130 mm, a maximum capacity of 2.81 Gbyte with land and groove recording, a recording time code as long as 318 minutes:59 seconds:74 frames, and a track pitch as short as 1.50-2.00 um.
